(19) United States
(12) Patent Application Publication
(10) Pub. No.: US 2023/0360116 A1
(43) Pub. Date: Nov. 9, 2023

(54) BATTERY LEASE SYSTEM

(71) Applicant: TOYO SYSTEM CO., LTD., Iwaki-shi, Fukushima (JP)

(72) Inventors: Hideki SHOJI, Fukushima (JP); Kenji IGARI, Fukushima (JP); Misaki SHIMOYAMADA, Fukushima (JP)

(73) Assignee: TOYO SYSTEM CO., LTD., Iwaki-shi, Fukushima (JP)

(21) Appl. No.: 18/027,242

(22) PCT Filed: Sep. 7, 2021
(86) PCT No.: PCT/JP2021/032824

§ 371 Date: Mar. 20, 2023

(30) Foreign Application Priority Data
Sep. 23, 2020 (JP) 2020-158723

(51) Int. Cl. G06Q 30/0645; G06Q 30/0283

(52) U.S. Cl. CPC G06Q 30/0645; G06Q 30/0283

(57) ABSTRACT

Provided is a battery lease system which can rationalize the burden of a user when using a battery and encourage the user to purchase an electric vehicle or the like effectively. The battery lease system accepts input of estimation basic information, estimates an estimated degradation state at the expiration of a scheduled lease term, determines a first lease fee of the battery, accepts input of information indicating that a first lease is started, and stores the information in a storage unit. Then, the battery lease system acquires battery information required to determine a degradation state of the battery returned after the expiration of the first lease of the battery, determines a degradation state of the returned battery, and redetermines a first lease fee based on the estimated degradation state and the degradation state of the returned battery.

### TECHNICAL FIELD

The present invention relates to a battery lease system.

### BACKGROUND ART

A battery lease system has conventionally been proposed (see Patent Literature 1).

### CITATION LIST

### Patent Literature

Patent Literature: Japanese Patent Application Laid-Open No. 2001-286006

### SUMMARY OF INVENTION

### Technical Problem

According, to the system of Patent Literature 1, a user who buys an electric vehicle can use the electric vehicle after getting a loan for a drive battery.

By the way, it is expected that electric vehicles and hybrid vehicles will become more widespread as environmentally friendly moving bodies compared with gasoline vehicles. However, since drive batteries are expensive and the electric vehicles and hybrid vehicles are generally more expensive than the gasoline vehicles, it is a barrier for people who are considering, purchasing vehicles to purchase the electric vehicles and hybrid vehicles.

Further, other moving bodies, such as electric bikes and those for slow mobility (electric wheelchairs and mobility for people with walking disabilities), or battery storage systems (so-called ESSs) for home or business have similar problems.

However, in Patent Literature 1, since only the burden at the time of purchase of an electric vehicle can be reduced without considering demonstrating to a person thinking about purchasing the electric vehicle that the cost while using a battery after getting a loan for the battery is reasonable, the effect that can remove the barrier for the person thinking about purchasing the electric vehicle is insufficient.

Therefore, it is an object of the present invention to provide a battery lease system that can rationalize the burden of a user when using a battery and encourage the user to purchase an electric vehicle, an electric bike, slow mobility, or a storage battery thereinafter called an electric vehicle or the like) effectively.

### Solution to Problem

A battery lease system of the present invention including:
an input reception unit, a degradation estimation unit; a first lease fee determination unit, a storage unit; a battery information acquisition unit; a degradation state determination unit; and a first lease fee re-determination unit; wherein
the input reception unit accepts input of estimation basic information including a scheduled lease term of a battery as a lease target and required to estimate a degradation state of the battery at the expiration of the scheduled lease term,
the degradation estimation unit estimates an estimated degradation state of the battery at the expiration of the scheduled lease term based on the estimation basic information,
the first lease fee determination unit determines a first lease fee of the battery based on the estimated degradation state,
the input reception unit accepts information indicating that the first lease of the battery is started and stores the information in the storage unit,
the battery information acquisition unit acquires battery information required to determine a degradation state of the battery returned after the expiration of the first lease of the battery,
the degradation state determination unit determines the degradation state of the returned battery based on the battery information, and
the first lease fee re-determination unit redetermines the first lease fee based on the estimated degradation state and the degradation state of the returned battery.

According to the present invention, the estimated degradation state of the battery at the expiration of the scheduled lease term is estimated by the degradation estimation unit, and the first lease fee of the battery is determined by the first lease fee determination unit based on the estimated degradation state.

Thus, a user who gets the lease (first lease) of the battery can know a reasonable lease fee according to the amount of degradation of the battery estimated to be degraded during the lease term.

Therefore, a person who considers purchasing an electric vehicle or the like can make a purchase decision after knowing the reasonable lease fee.

Further, the degradation state of the battery returned after the expiration of the first lease is determined by the degradation state determination unit, and the first lease fee is redetermined by the first lease fee re-determination unit based on the estimated. degradation state and the degradation state of the returned battery.

Thus, since the first lease fee is redetermined according to the actual degradation state of the battery returned after the expiration of the lease, the user has only to pay a lease fee depending on art of the fee of the battery degraded during the lease term. In this respect, the lease fee of the battery is reasonable.

Thus, according to the present in the burden of the user when using the battery is rationalized and the user can be encouraged to purchase an electric vehicle or the like effectively.

The lease system of the present invention is preferred to further include: a reuse application determination unit, and a second lease fee determination unit, wherein
the reuse application determination unit determines a reuse application as a next application 01 the battery based on the degradation state of the returned battery, and
the second lease fee determination unit determines a second lease fee of the battery for a second lease based on the reuse application.

According to the present invention, since a price range of lease fees of the battery differs depending on the reuse application, there is a need to determine a lease fee according to the reuse application in addition to the degradation state of the batters when the lease lee in the reuse application is determined. This is because, if a lease fee that is oat of the price range of lease fees in the reuse application is determined, the battery will be left without being reused its the end.

According to the present invention, the degradation state of the battery returned after the end of the first lease is determined by the degradation state determination unit, a reuse application of the battery is determined by the reuse application determination unit based on the degradation state, and a second lease fee of the battery for a second lease is determined by the second lease fee determination unit based on the reuse application. After that, the lease (second lease) in the reuse application is made.

Thus, a battery leasing operator can recover the cost of procuring the battery from not only a profit when the battery is leased (first lease) as a battery for an electric vehicle or the like, but also a profit from the lease (second lease) in the reuse application.

Therefore, it is more likely to be able to set the first lease fee cheaper than that when the battery is leased only for the electric vehicle or the like.

In other words, the certainty that the reduction in the burden of the user and the assurance of the profit of the leasing, operator can be balanced increases,

Further, since the second lease fee is determined based on the reuse application, the possibility that a lease fee that is out of the price range of lease fees in the reuse application is determined and hence the battery is left without being reused can be reduced. As a result, it is more likely to be able to make a profit from the lease (second lease) in the reuse application.

Thus, according to the present invention, the certainty that the burden of the user when using the battery can be rationalized increases, and hence it is possible to encourage the user to purchase the electric vehicle or the like effectively.

The battery lease system of the present invention is also preferred to he such that
the input reception unit accepts input of information indicative of a current value of the battery as a lease target, and
the first lease fee determination unit predicts a predictive value of the battery at the expiration of the scheduled lease term based on the estimated degradation state, and determines the first lease lee of the batters based on a predicted decrease value obtained by subtracting the predictive value from the current value of the battery.

According to the present invention, the predictive value at the expiration of the scheduled lease term of the battery is determined by the first lease the determination unit based on the estimated degradation state, and the first lease fee of the battery is determined based on the predicted decrease value Obtained by subtracting the predictive value from the current value of the battery.

Thus, since the first lease fee is determined based on an objective value as die predictive value of the battery predicted to decrease during the lease term, both the user of the battery and the battery leasing operator can get high satisfaction for the first lease fee.

Thus, according to the present invention, the burden of the user when using the battery can be rationalized while giving a high sense of satisfaction fix the lease fee, and hence it is possible to encourage the user to purchase the electric vehicle Of the like effectively.

The battery lease system of the present invention is further preferred to be such that
the battery information acquisition unit acquires the battery information of the battery during the first lease regularly or irregularly while the first lease is in progress,
the degradation state determination unit determines the degradation state of the battery during the first lease based on the battery information, and
the first lease fee re-determination unit redetermines the first lease fee based on the degradation state of the battery during the first lease.

It van be considered that the progress of deterioration of the battery during the lease is different depending on the individual difference of the leased battery or the usage of the battery.

According to the present invention, the battery information of the battery during the first lease is acquired by the battery information acquisition unit regularly or irregularly while the first lease is in progress, the degradation state of the battery during the first lease is determined by the degradation state determination unit based on the battery information, and the first lease fee is redetermined by the, first lease fee re-determination unit based on the degradation state of the battery.

Thus, since the first lease fee is redetermined according to the actual degradation state of the battery during the first lease, the sense of satisfaction of both the user and the leasing operator for he first lease fee increases.

Thus, according to the present invention, the burden of the user when using the battery can be rationalized while giving a high sense of satisfaction for the lease fee, and hence it is possible to encourage the user to purchase the electric vehicle or the like effectively.

The battery lease system of the present invention is also preferred to further include:
a usage history recording unit; a usage history acquisition unit; and a degradation cause estimation unit, wherein
the input reception unit accepts input of planned usage information composed of information indicative of planned discharge amount of a device in which the battery as a lease target is installed during the scheduled lease term,
the input reception unit stores the estimated degradation state and the planned usage information in the storage unit,
the usage history recording unit records usage history information of the battery during the first lease while the first lease of the battery is in progress,
the usage history acquisition unit acquires the usage history information recorded by the usage history recording unit,
the degradation cause estimation unit determines whether or not the degradation state of the battery determined by the degradation state determination unit is abnormal compared with the estimated degradation state, and when determining alai the degradation state is abnormal, the degradation cause estimation unit estimates a cause of the abnormal degradation state based on the planned usage information and the usage history information, and
when the cause estimated by the degradation cause estimation unit occurs as a result of the fact that the user of the battery used the battery in a way different from the planned usage information, the first lease fee re-determination unit redetermines the first lease fee based on the usage history information and the degradation state of the battery determined by the degradation state determination unit.

If the progress of the deterioration state of the battery is abnormal and the cause thereof is the usage of the user, it will be reasonable that the user should carry its fair share of burden.

According to the present invention, input of the planned usage information composed of information indicative of the planned discharge amount is accepted by the input reception unit, and the planned usage information is stored in the storage unit together with the estimated degradation state at the start of the first lease.

Further, the usage history information of the battery during the first lease is recorded by the usage history recording unit.

After that, when it is determined by the degradation cause estimation unit that the degradation state of the battery is abnormal compared with the estimated degradation state, the cause of the abnormal degradation state is estimated.

Then, when the cause of the abnormal degradation state occurs as a result of the fact that the user of the battery used the battery in a way different from the planned usage information, the first lease fee is redetermined by the first lease fee re-determination unit based on the usage history information and the degradation state of the battery.

Thus, when the progress of the degradation state of the battery is abnormal and the cause thereof is the usage of the user, it is reasonable that the user should carry its fair share of burden.

Further, since it is considered that the user of the battery who knows it tries not to deviate from the planned usage, it can be expected that the certainty that the battery in the degradation state as estimated is returned increases.

Thus, according to the present invention, the burden of the user when using the battery can be rationalized in consideration of the cause of the abnormal degradation state as well, and hence it is possible to encourage the user to purchase the electric vehicle or the like effectively.

Further, the battery lease system of the present invention is preferred to further include
an exchange recommendation unit,
wherein when the cause estimated by the degradation cause estimation unit does not occur as the result of the fact that the user of the battery used the, battery in the way different from the planned usage information, the exchange recommendation unit generates information to recommend the battery exchange.

When the progress of the degradation state of the battery is abnormal but the cause thereof is not the usage of the user, since it is considered that the battery is defective, the battery should be exchanged.

According to the present invention, when the cause of the abnormal degradation state is not due to the fact that the user of the battery used the battery in a way different from the planned usage information, the information to recommend the battery exchange is generated by the exchange recommendation unit.

Thus, when the progress of the degradation state of the battery is abnormal but the cause thereof is not the usage of the user, since the battery can be exchanged timely, the user of the battery can be given a sense of security.

Thus, according to the present invention, the burden of the user of the battery when using, the battery can be rationalized while giving a high sense of satisfaction, and hence it is possible to encourage the user to purchase the electric vehicle or the like effectively.

Further, the battery lease system of the present invention is preferred to further include:
a usage, history recording unit; a usage history acquisition unit and a degradation trend acquisition unit, wherein
the usage history recording unit records usage history information of the battery during, the first lease while the first lease of the battery is in progress,
the usage history acquisition unit acquires the usage history information of the battery returned after the expiration of the first lease of the battery,
the degradation trend acquisition unit acquires a degradation trend of the battery based on the usage history information, and
the reuse application determination unit determines the reuse application of the battery based on the degradation state and the degradation trend of the returned battery, or the second lease fee determination unit determines the second lease fee based on the reuse application and the degradation trend of the battery.

It is assumed that the degree of degradation differs from battery to battery. Therefore, it is desirable to determine, a reuse application based on reality or a usage fee for reusing the battery in consideration of the degradation trend of the battery.

According to the present invention, the usage history information of the battery during the first lease is recorded by the usage history recording unit, and the degradation trend of the battery returned after the exudation of the first lease is acquired by, the degradation trend acquisition unit based on the usage history information.

Then, the reuse application of the battery is determined by the reuse application determination unit based on the degradation state and degradation trend of the returned battery, or the second lease fee is determined by the second lease fee determination unit based on the reuse application and degradation trend of the battery.

Thus, since the reuse application or the second lease fee is determined in consideration of the degradation trend based on the usage history information when the battery was actually used, the reuse application based on reality or the usage fee for reusing the battery can be, determined. As a result, it is more likely to be able to profit from the lease (second lease) in the reuse application.

Thus, according to the present invention, the certainty that the burden of the user when using the battery can be rationalized increases, and hence it is possible to encourage the user to purchase the electric vehicle or the like effectively.

Further, the battery lease system of the present invention is preferred to be such that
the degradation trend acquisition unit has a degradation trend determination model with the usage history information of the battery as input and the degradation trend of the battery as output,
the degradation trend acquisition unit learns, as training data, the usage history information of the battery and the degradation state of the battery after being used as indicated by the usage history information, and updates the degradation trend determination model regularly or irregularly, and
the degradation trend acquisition unit acquires the degradation trend of the battery using the usage history information and the degradation trend determination model.

According to the present invention, the degradation trend acquisition unit has the degradation trend determination model with the usage history information of the battery as input and the degradation trend of the battery as output, the usage history information of the battery and the degradation state of the battery after being used as indicated by the usage history information are learned by the degradation trend acquisition unit as training data, and the degradation trend determination model is updated regularly or irregularly.

Then, the degradation trend of the battery is acquired by the degradation trend acquisition unit using the usage history information and the degradation trend determination model.

Thus, since the degradation trend of the battery is acquired using the appropriately updated degradation trend determination model of the battery, the determination accuracy of the degradation trend increases. As a result, it is more likely to be able to profit from the lease (second lease) in the reuse application.

Thus, according to the present invention, the certainty that the burden of the user when using the battery can be rationalized increases, and hence it is possible to encourage the user to purchase the electric vehicle or the like effectively.

The battery lease system of the present invention is preferred to further include
a lease management device having an output control unit, wherein
the battery information acquisition unit acquires the battery information of the battery during the first lease or the second lease regularly or irregularly while the first lease or the second lease of the battery is in progress,
the degradation state determination unit determines a degradation state of the battery during the first lease or the second lease based on the battery information, and
the output control unit outputs, to the lease management device, information indicative of the degradation state of the battery during the first lease or the second lease based on the degradation state of the battery.

If the leasing operator manages the degradation state of the battery from the first lease term to the second lease term, the user of the battery can use the leased battery with a sense of security.

According to the present invention, the degradation state of the battery being leased is deter by the degradation state determination unit based on the battery information regularly or irregularly while the first lease or the second lease of the battery is in progress, and the information indicative of the degradation state of the battery is output by the output control unit to the lease management device.

Thus, since the degradation state of the battery being leased is automatically output to the leasing operator so that the leasing operator can manage the degradation state effectively from the first lease term to the second lease term, the user of the battery can use the leased battery with a sense of security.

Thus, according to the present invention, the burden of the user of the battery when using the battery can be rationalized while giving a sense of security, and hence it is possible to encourage the, user to purchase the electric vehicle or the like effectively.

Further, the battery lease system of the present invention is preferred to be such that when there is no reuse application corresponding to the degradation state of the returned battery determined by the degradation state determination unit, the reuse application determination unit generates information to recommend recycling of the battery.

According to the present invention, when there is no reuse application corresponding to the degradation state of the battery, the information to recommend recycling of the battery is generated by the reuse application determination unit.

Thus, when there is no reuse application corresponding to the degradation state of the battery; the battery can be recycled timely.

Further, the battery leasing operator can recover the cost of procuring the battery from the profit of battery recycling. Therefore, it is more likely to be able to set the first lease fee cheaper.

Thus, according to the present invention, the certainty that the burden of the user when using, the battery can be rationalized increases, and hence it is possible to encourage the user to purchase the electric vehicle or the like effectively.

### BRIEF DESCRIPTION OF DRAWINGS

FIG. 1 is a block diagram illustrating an overall picture of a battery lease system of the present invention.

FIG. 2A is a table illustrating a data content used in processing by the battery lease system of the present invention.

FIG. 2B is a table illustrating a data content used in processing by the battery lease system of the present invention.

FIG. 3A is a chart illustrating processing details of the battery lease system of the present invention.

FIG. 3B is a chart illustrating processing details of the battery lease system of the present invention.

FIG. 4A is a flowchart illustrating processing details of the battery lease system of the present invention.

FIG. 4B is a flowchart illustrating processing details of the battery lease system of the present invention.

FIG. 4C is a flowchart illustrating processing details of the battery lease system of the present invention.

FIG. 5 is a flowchart illustrating processing details of the battery lease system of the present invention.

### DESCRIPTION OF EMBODIMENT

### <Configuration of Battery Lease System>

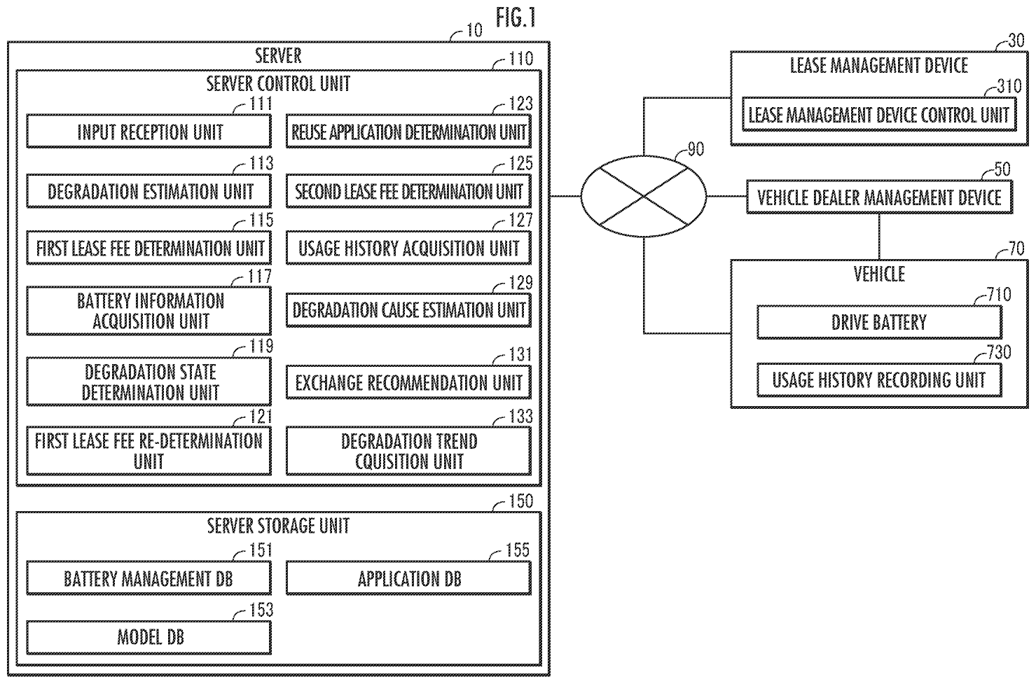

Referring first to FIG. 1, the configuration of a battery lease system of an embodiment will be described. Note that the description of the same components may be omitted by giving the same signs.

The battery lease system of the present embodiment is a lease system, for example, for a drive battery 710 of an electric vehicle or a hybrid vehicle (or for a reuse battery that was the drive battery 710 of the electric vehicle or the hybrid vehicle), which is configured to include a server 10 for the lease system, a Lease management device 30 as needed, and a vehicle dealer Management unit 50. Each of the server 10, the lease management device 30, and the vehicle dealer management unit 50 may be one or plural, respectively.

The server 10 and the lease management device 30, and the server 10 and the vehicle dealer management unit 50 are communicably connected with each other through a communication network 90.

The server 10 is a computer configured to include, for example, a server control unit 110 and a server storage unit 150.

The server control unit 110 is composed of an arithmetic processing unit such as a CPU (Central Processing Unit), memories, I/O (Input/Output) devices, and the like. The server control unit 110 reads and executes a prescribed program to function, for example, as an input reception unit 111, a degradation estimation unit 113, a first lease fee determination unit 115, a battery information acquisition unit 117, a degradation state determination unit 119, and a first lease fee re-determination unit 121, or further as a reuse application determination unit 123, a second lease fee determination unit 125, a usage history acquisition unit 127, and a degradation cause estimation unit 129.

The input reception unit 111 accepts input of estimation basic information including a scheduled lease term of a battery as a lease target and required to estimate the degradation state of the battery at the expiration of the scheduled Lease term. Further, the input reception unit 111 accepts input of information indicating that a first lease of the battery is started, and stores the information in the server storage unit 150.

The degradation estimation unit 113 estimates an estimated degradation state of the battery at the expiration of the scheduled lease term of the battery based on the estimation basic information.

The first lease fee determination unit 115 determines a first lease fee of the battery based on the estimated degradation state.

The battery information acquisition unit 117 acquires battery information required to determine the degradation state of the battery the first lease of which is ended and returned.

The degradation state determination unit 119 determines the degradation state of the returned battery based on the battery information.

The first lease fee re-determination unit 121 redetermines the first lease fee based on the estimated degradation state and the degradation state of the returned battery.

The reuse application determination unit 123 determines a reuse application as a next application of the battery based on the degradation state of the returned battery.

The second lease fee determination unit 125 determines a second lease fee for a second lease of the battery based on the reuse application.

For example, the usage history acquisition unit 127 acquires usage history information recorded by a usage history recording unit 730 of a vehicle 70.

The degradation cause estimation unit 129 determines whether or not the degradation state of the battery determined by the degradation state determination unit 119 is abnormal compared with the estimated degradation state, and when determining that the degradation state is abnormal, the degradation cause estimation unit 129 estimates the cause of the abnormal degradation state based on planned usage information and the usage history information.

When the cause estimated by the degradation cause estimation unit 129 does not occur as a result of the fact that a user used the battery in a way different from the planned usage information, an exchange recommendation unit 131 generates information to recommend the battery exchange.

A degradation trend acquisition unit 133 acquires a degradation trend of the battery based on the usage history information.

The server storage unit 150 is composed, for example, of storage devices such as a ROM (Read Only Memory), a RAM (Random Access Memory), an HDD (Hard Disk Drive), and the like. For example, the server storage unit 150 stores information required for processing, by the lease system and the processing results in addition to a battery management DB (database) 151, a model DB 153, and an application DB 155, which functions as a storage unit in the present embodiment.

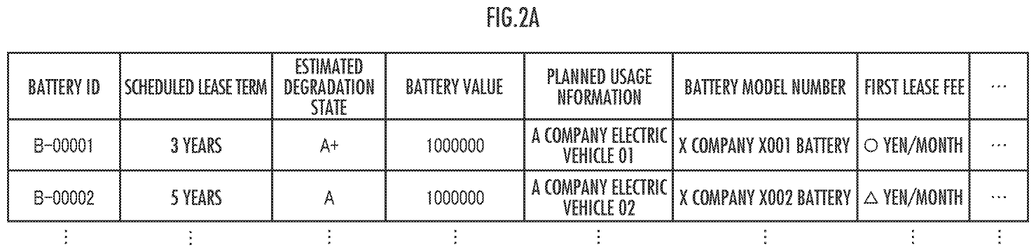

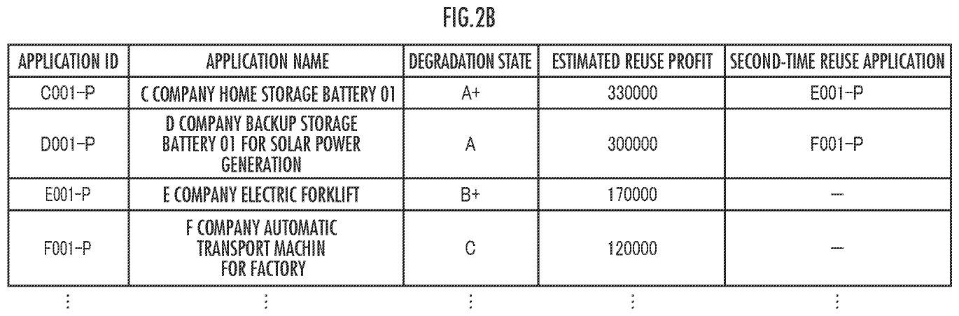

The battery management DB 151 is a database for storing information for battery management. For example, information required for processing by the lease system is stored, such as a lease destination ID used to identify a lease destination, a first lease flag indicative of the start of the first lease, the total amount received as the total amount of first lease fee paid during the first lease term, an end-of-first lease flag, a current degradation state, a returned-time degradation state, a degradation trend, a reuse application, a second lease fee, and usage history information, in addition to a battery ID used to identify a battery as a lease target, a scheduled lease term, an estimated degradation state, a battery value, planned usage information, the model number of the battery (manufacture name, product name etc.), and a first lease fee as illustrated in FIG. 2A.

The model DB 153 stores, for example, for each battery model number, a degradation trend determination model with the usage history information of the battery as input and the degradation trend of the battery as output. Note that the usage history information of the battery and the degradation state of the battery after being used as indicated by the usage history information are learned as training data by the degradation trend acquisition unit 133, and the degradation trend determination model is updated regularly or irregularly.

In the application DB 155, for example, information required for processing by, the lease system is stored in addition to an application ID used to identity an application, an application name, the degradation state of a battery that can be used for the application, an estimated reuse profit estimated to be made by reusing the battery for the application, and an application ID for a second-time reuse application when there is the second-time reuse application as illustrated in FIG. 2B.

The lease management device 30 is configured to include a lease management device control unit and an output unit, which is, for example, a personal computer, a tablet terminal, a smartphone, or the like used a person in charge of the leasing operator.

The lease management device control unit 310 is composed of an arithmetic processing unit such as a CPU, memories, I/O devices, and the like. The lease management device control unit 310 reads and executes a predetermined program to function, for example, as an output control unit.

Based on the degradation state of the battery, the output control unit generates information indicative of the degradation state of the battery during a first lease or a second lease, and outputs the information to the output unit of the lease management device 30, for example.

The output unit is, for example, a display or a printer.

The vehicle dealer management unit 50 is, for example, a cant used by a vehicle dealer person in charge, which is used when being connected to the vehicle 70 to acquire the usage history information of the drive battery 710 or the like.

The vehicle 70 is configured to include the drive battery 710 and the usage history recording unit 730. For example, the vehicle 70 is a vehicle using electricity as all or part of its driving force such as an electric vehicle or a hybrid vehicle.

The vehicle 70 is connected to the server 10 through the communication network 90 continuously or intertmittently in a manner to he able to communicate with each other, or the vehicle 70 is connected to the server 10 through the vehicle dealer management unit 50 intermittently in a manner to be able to communicate with each other.

The drive battery 710 is, tor example, a lithium-ion battery, but it may also be any other battery that can be used repeatedly as a power supply by repeating charging and discharging (so-called secondary battery) such as a nickel-cadmium battery, a lead battery, or a fuel battery.

The usage history recording unit 730 is composed, for example, of storage devices such as a ROM, a RAM, and an HDD. The usage history recording unit 730 records the usage history information of the battery during the first lease while the first lease of the battery is in progress, for example, according to processing of a control mechanism of the vehicle 70.

The usage history recording unit 730 records into as usage history record information that can he compared with planned usage in in chronological order, where the usage history record information includes, for example, the distance traveled, the amount of power discharged, the number of normal charges or quick charges, the charging time, the amount of power charged, the voltage value at the time, the remaining battery capacity, the temperature of the drive battery 710, the air temperature, the weather, the presence or absence of use of an air conditioner, the temperature setting of the air conditioner, the tilt of the vehicle, the speed, position information, and user characteristic information.

### <Overview of Processing>

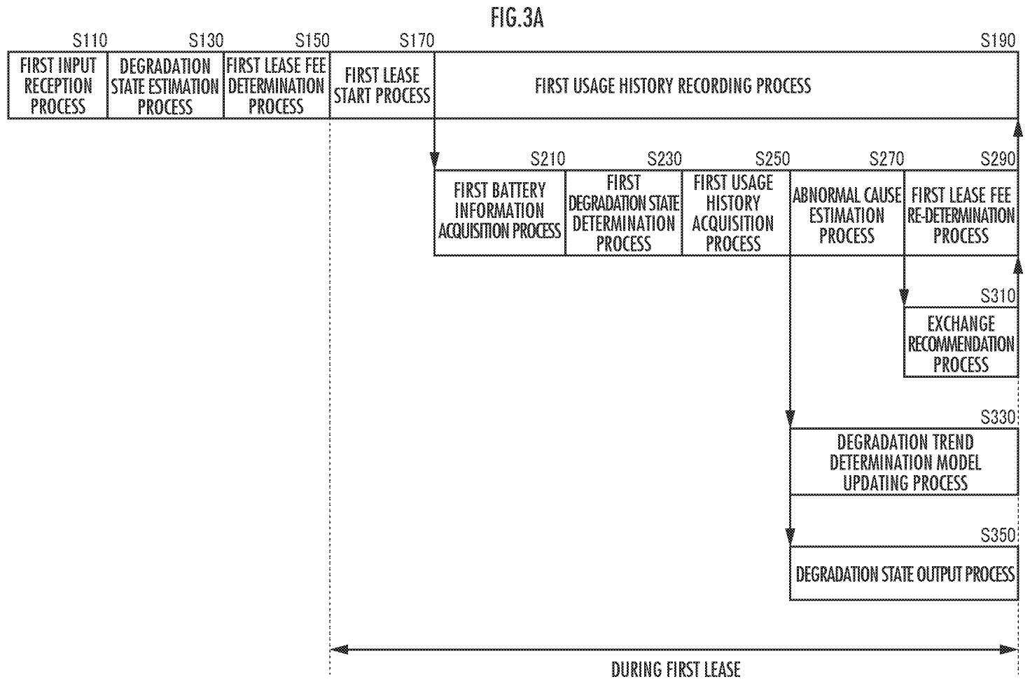

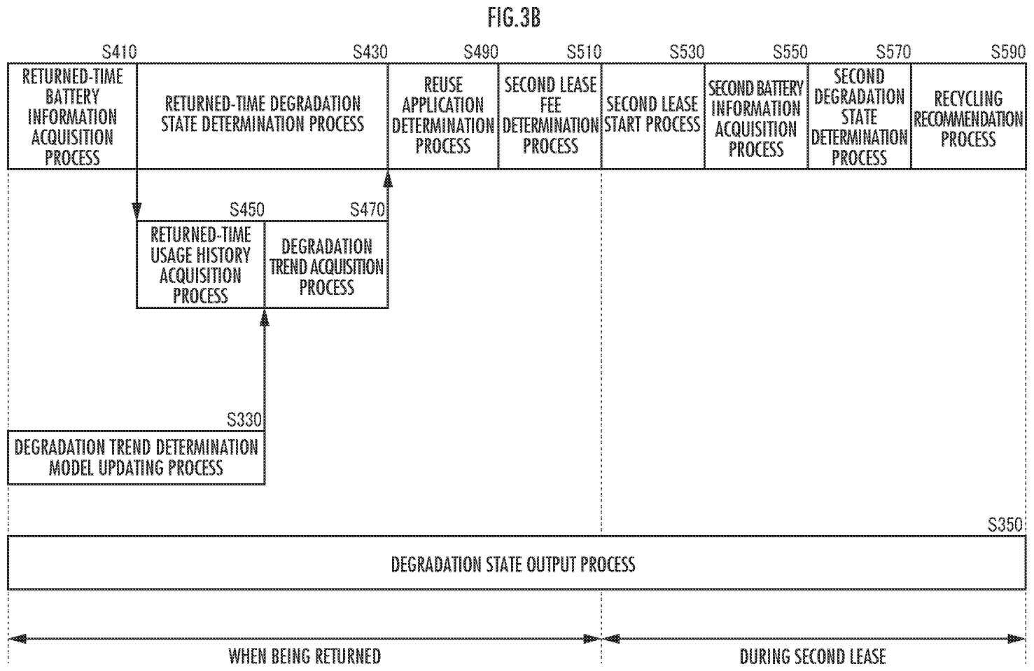

Next, the processing details of the battery lease system of the present embodiment will be described. Referring first to FIG. 3A and FIG. 3B, a series of processes by the battery lease system will be described. Note that the details of each process will be described later.

The battery lease system of the present embodiment first executes a first input reception process (FIG. 3A/S110), a degradation state estimation process (FIG. 3A/S130), and a first lease fee determination process (FIG. 3A/S150) as preparatory processes for putting the first lease of the battery into action.

After that, the first lease is started through first lease start process (FIG. 3A/S170), and a first usage history recording process (FIG. 3A/S190) is executed during the first lease. During this period, a first battery information acquisition process (FIG. 3A/S210), a first degradation state determination process (FIG. 3A/S230), a first usage history acquisition process (FIG. 3A/S250), an abnormal cause estimation process (FIG. 3A/S270), and a first lease fee re-determination process (FIG. 3A/S290) to redetermine the first lease fee in parallel. Alternatively, an exchange recommendation process (FIG. 3A/S310) may be executed in addition to or instead of the first lease fee re-determination process.

During a period after the first leased battery is returned until the second lease is started, a returned-time battery information acquisition process (FIG. 3B/S410), returned-time degradation state determination process (FIG. 3B/S430), a returned time usage history acquisition process (FIG. 3B/S450), a degradation trend acquisition process (FIG. 3B/S470), a reuse application determination process (FIG. 3B/S490), and a second lease fee determination process (FIG. 3B/S510) are executed as preparatory processes for putting the second lease of the battery into action. Further, a degradation trend determination model updating process (S330/FIG. 3A and FIG. 3B) to update the model for determining the degradation trend of the batters may be performed at any timing from the first usage history acquisition process (FIG. 3A/S250) to the degradation trend acquisition process (FIG. 3B/S470).

After that, the second lease is started through a second lease start process (FIG. 3B/S530), a second battery information acquisition process (FIG. 3B/S550), a second degradation state determination process (FIG. 38/S570), and a recycling recommendation process (FIG. 3B/S590) are executed during the second lease, and the series of processes are completed.

Note that a degradation state output process (S350/FIG. 3A and FIG. 3B) to output the degradation state of the battery may also be performed at any timing from the first usage history acquisition process (FIG. 3A/S250) to the recycling recommendation process (FIG. 3B/S590).

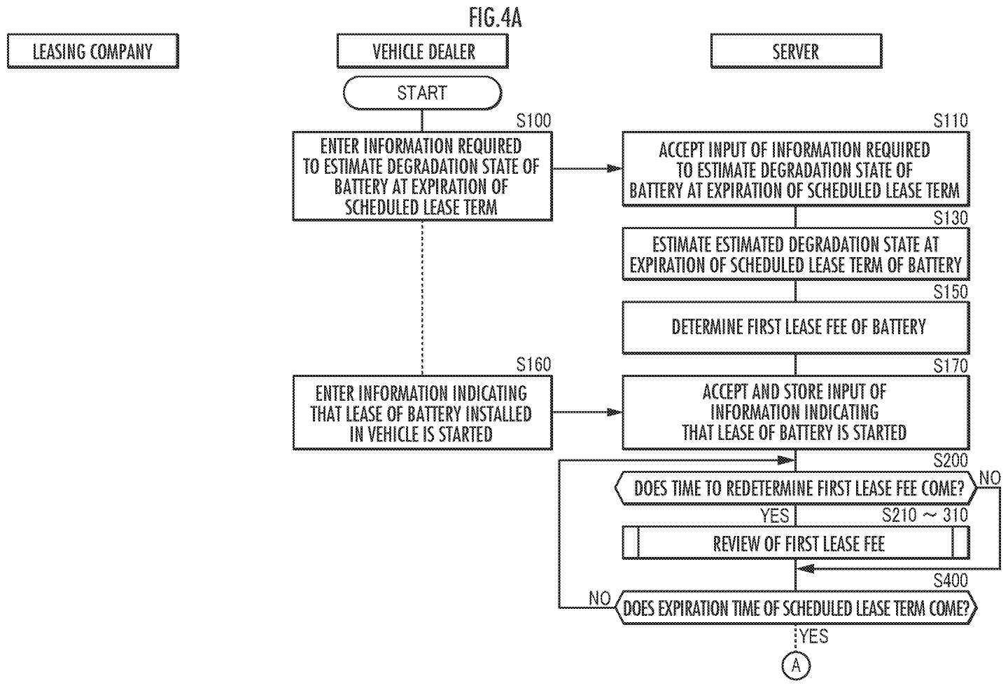

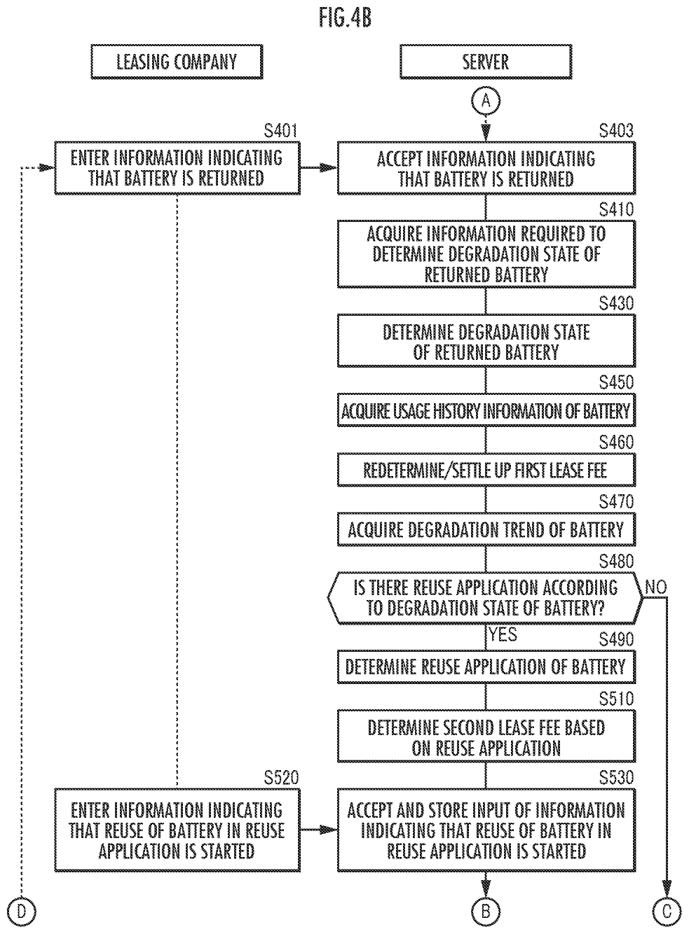

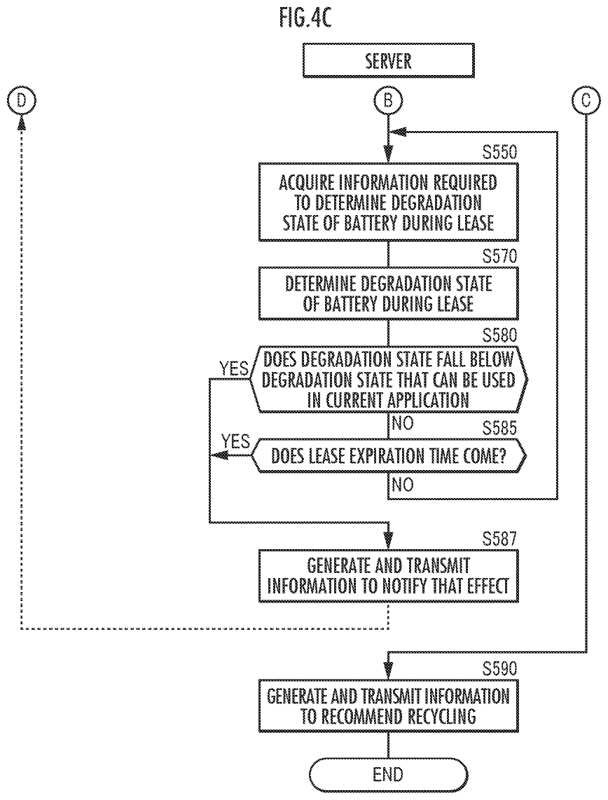

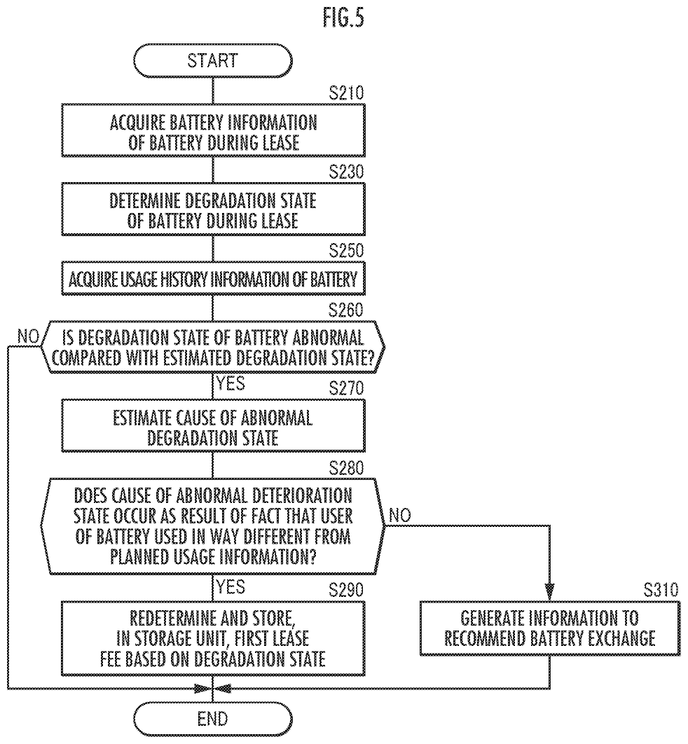

Referring next to FIG. 4A to FIG. 4C and FIG. 5, the details of each of individual processes will be described.

<First Input Reception Process>

The first input reception process is started, for example, by the vehicle dealer person in charge entering information required to estimate the degradation state of the batters at the expiration of the scheduled lease term (FIG. 4A/S100).

Here, the input reception unit 111 accepts input of estimation basic information he scheduled lease term of the drive battery 710 as a lease target and required to estimate the degradation state of the drive battery 710 at the expiration of the scheduled lease term (FIG. 4A/S110).

In addition to the scheduled lease term, for example, the estimation basic information includes information indicative of the characteristics of the drive battery 710 such as the battery type (maker, model number, and the like) and the performance (battery capacity, current-voltage characteristics, and the like), planned usage information including a planned traveling distance during the lease term, the type of the vehicle 70, the user characteristics of the user (age, gender, occupation, accident history, family structure, home/workplace addresses, and the like), and information indicative of the current value of the drive battery 710. Note that the information of the planned traveling distance during the lease term corresponds to “information indicative of a planned discharge amount during the scheduled lease term” in the present embodiment.

### <Degradation State Estimation Process>

After that, the degradation estimation unit 113 estimates an estimated degradation state of the drive battery 710 at the expiration of the scheduled lease term based on the estimation basic information (FIG. 4A/S130).

As the method used by the degradation estimation unit 113 to estimate the estimated degradation state, various methods can be adopted. For example, the degradation estimation unit 113 estimates the estimated degradation state using a function of outputting the estimated degradation state with the estimation basic information as input, using a discriminator, or the like.

### <First Lease Fee Determination Process>

Then, the first lease fee determination unit 115 determines the first lease fee of the drive battery 710 based on the estimated degradation state (FIG. 4A/S150).

For example, based on the estimated degradation state, the first lease fee determination unit 115 predicts a predictive value of the drive battery 710 at the expiration of the scheduled lease term to determine, as the first lease fee of the drive battery 710, a value obtained by multiplying, by a predetermined lease fee rate, a predicted decrease value obtained as a result of subtracting, the predictive value from the current value of the drive battery 710.

As the method used by the first lease fee determination unit 115 to estimate the estimated value at the expiration of the scheduled lease term, various methods can be adopted. For example, the first lease fee determination unit 115 refers to the application DB to estimate a reuse application after the expiration of the scheduled lease term, estimates a second-time reuse application when there is any second-time reuse application, adds up respective estimated reuse profits estimated by a predetermined algorithm, and determines a value obtained by multiplying the amount of profit by a predetermined expected value as the predictive value at the expiration of the scheduled lease term of the drive battery 710.

### <First Lease Start Process>

After that, for example, when the vehicle dealer person in charge enters information indicating that the lease of the drive battery 710 installed in the vehicle 70 is started (FIG. 4A/S160), the first lease start process is executed.

In the first lease start process, the input reception unit 111 accepts input of information indicative of the start of the first lease of the drive battery 710, and stores the information in the server storage unit 150 (FIG. 4A/S170).

### <First Usage History Recording Process>

The first usage history recording process (FIG. 3A/S190) described with reference to FIG. 3A is executed while the first lease of the drive battery 710 is in progress. In the first usage history recording process, the usage history recording unit 730 records the usage history information of the drive battery 710 during the first lease,

During this period, a series of processes (FIG. 4A/S200, FIGS. 5/S210 to S310, FIG. 4A/5400) are executed in parallel to redetermine the first lease fee. These processes will be described later.

### <Returned-Time Battery Information Acquisition Process>

After that, when information indicating that the drive battery 710 installed in the vehicle 70 is returned is entered, for example, by the vehicle dealer person in charge (FIG. 4B/S401), and when the input reception unit 111 accepts the information (FIG. 4B/S403), the returned-time battery information acquisition process is executed.

In the returned-time battery information acquisition process, the battery information acquisition unit 117 acquires battery information required to determine the degradation state of the returned drive battery 710 (FIG. 4B/S410).

More specifically, for example, the vehicle dealer management unit 50 has a terminal to connect to the drive battery 710 or an information output mechanism of the vehicle 70, Then, by connecting the terminal to the drive battery 710 or the information output mechanism of the vehicle 70, the battery information acquisition unit 117 acquires, through the vehicle dealer management unit 50, information such as a power value, a voltage value, and a temperature, obtained by the vehicle dealer management unit 50 charging and discharging the drive battery 710, as battery information required to determine the degradation state.

### <Returned-Time Degradation State Determination Process>

After that, the degradation state determination unit 119 determines the degradation state of the returned drive battery 710 based on the battery information (FIG. 4B/S430).

For example, the degradation state determination unit 119 determines, as the degradation state of the drive battery 710, SOH (State Of Health) of the drive battery 710 from the information such as the power value, the voltage value, and the temperature acquired in the returned-time battery information acquisition process. Alternatively, for example, the degradation state determination unit 119 may determine the remaining life of the drive battery 710 from these pieces of information.

### <Returned-Time Usage History Acquisition Process>

Then, the usage history acquisition unit 127 acquires usage history information on the drive battery 710 returned after the first lease expires (FIG. 4B/S450).

More specifically, for example, the vehicle dealer management unit 50 has the terminal to connect to the drive battery 710 or the information output mechanism of the vehicle 70, and the usage history acquisition unit 127 acquires usage history information from the usage history recording unit 730 of the drive battery 710 as a result of connecting the terminal to the drive battery 710 or the information output mechanism of the vehicle 70. Alternatively, the usage history acquisition unit 127 may acquire the usage history information from the usage history recording unit 730 via wireless communication or through a medium such as a recording medium or any other medium.

After that, although the first lease fee is redetermined or settled as necessary (FIG. 4B/S460), the details of this process will be described later.

### <Degradation Trend Acquisition Process>

Next, the degradation trend acquisition unit 133 acquires the degradation trend of the drive battery 710 based on the usage history information (FIG. 4B/S470).

More specifically, for example., the degradation trend acquisition unit 133 has the degradation trend determination model with the usage history information of the drive battery 710 as input and the degradation trend of the drive battery 710 as output, and the degradation trend acquisition unit 133 acquires the degradation trend of the drive battery 710 using the usage history information and the degradation trend determination model.

In this case, for example, the degradation trend acquisition unit 133 learns, as training data, the usage history information of the drive battery 710 and the degradation state of the drive battery 710 after being used as indicated by the usage history information, and updates the degradation trend determination model regularly or irregularly (S330/FIG. 3A and FIG. 3B).

### <Reuse Application Determination Process>

Then, when there is a reuse application according to the degradation state of the returned drive battery 710 (FIG. 4B/S480: Yes), the reuse application determination unit 123 determines the reuse application of the drive battery 710 (FIG. 4B/S490).

In other words, for example, the reuse application determination unit 123 refers to the application DB 155 to determine the reuse application according to the degradation state of the returned drive battery 710.

### <Second Lease Fee Determination Process>

Then, the second lease fee determination unit 125 determines a second lease fee for a second lease of the returned drive battery 710 based on the reuse application (FIG. 4B/S510).

In other words, for example, the second lease fee determination unit 125 stores a correspondence table between each reuse application and each second lease fee in advance in the server storage unit 150 or the like, and refers to the correspondence table to determine the second lease fee according to the reuse application of the returned drive battery 710.

### <Second Lease Start Process>

Then, when information indicating that the lease of the batter in the reuse application is started is entered by a person in charge of the lease company (FIG. 4B/S520), the second lease start process is executed.

In the second lease start process, the input reception unit 111 accepts the information indicating that the lease of the battery in the reuse application is started, and stores the information in the server storage unit 150 (FIG. 4B/S530).

<Second Battery information Acquisition Process>

After that, the battery information acquisition unit 117 acquires, from the battery, information required to determine the degradation state of the battery during the lease in the reuse application (FIG. 4C/S550).

More specifically, for example, the battery information acquisition unit 117 communicates with a device in which the battery during the lease in the reuse application is installed to acquire information such as the power value, the voltage value, and the temperature of the battery as battery information required to determine the degradation state.

### <Second Degradation State Determination Process>

Then, based on the battery information required to determine the degradation state, the degradation state determination unit 119 determines the degradation state of the battery during the second lease (FIG. 4/S570). The determination method is, for example, the same as that in the returned time degradation state determination process (S430/FIG. 3B and FIG. 4B).

In this case, for example, when the degradation state falls below a degradation state capable of being used in the current application (FIG. 4C/S580: Yes), the degradation state determination unit 119 generates information to notify that effect, and transmits the information (FIG. 4C/S587) to store the information in the server storage unit 150, and the input reception unit 111 goes into a state of waiting for input of the information indicating that the battery is returned (FIG. 4B/S401). The output control unit of the lease management device 30 receives the information and outputs the. information to a display or the like.

Then, the lease system of the present embodiment repeatedly executes the series of processes so far regularly or irregularly until the expiration of the second lease of the battery comes (FIG. 4C/S585).

### <Recycling Recommendation Process>

When it is determined that there is no reuse application according to the degradation state of the returned battery (FIG. 4B/S480: No), the recycling recommendation process is executed.

When there is no reuse application corresponding to the degradation state of the returned drive battery 710 or alter being reused determined by the degradation state determination unit 119, the reuse application determination unit 123 generates information to recommend recycling of the battery and transmits them info to the lease, management device 30 (FIG. 4C/S590).

### <Processes for Redetermining First Lease Fee>

Referring to FIG. 4A and FIG. 5, a series of processes to redetermine the first lease lee will be described. The processes are executed, for example, when the time to redetermine the first lease fee comes (FIG. 4A/S200: Yes). For example, the time to redetermine the first lease fee is the, timing of the periodic inspection of the vehicle or the like.

When the processes are started, the battery information acquisition unit 117 first acquires the battery information of the drive battery 710 during the first lease (FIG. 5/S210), and the degradation state determination unit 119 determines the degradation state of the drive battery 710 during the first lease based on the battery in enation (FIG. 5/S230).

Then, the usage history acquisition unit 127 acquires the usage history information of the drive battery 710 (FIG. 5/S250).

Then, when the degradation state of the drive battery 710 is abnormal compared with the estimated degradation state (FIG. 5/S260: Yes), the degradation cause estimation unit 129 estimates the cause of the abnormal degradation state (FIG. 5/S2701).

Note that the degradation cause estimation unit 129 determines whether or not the degradation state of the drive battery 710 is abnormal compared with the estimated degradation state by simulating a change in the degradation state, for example, when the drive battery 710 is used in the way of the planned usage, comparing the simulated. degradation state with the degradation state of the drive battery 710, and determining whether or not the difference therebetween is a predetermined level or more.

Then, when the cause of the abnormal degradation state occurs as a result of the fact that the user of the drive battery 710 used the drive battery 710 in a way different from the planned usage information (FIG. 5/S280: Yes), the first lease fee re-determination unit 121 redetermine the first lease fee based on the degradation state of the drive battery 710 during the first lease, and stores the redetermined first lease fee in the server storage unit 150.

As the method used by the first lease fee re-determination unit 121 to redetermine the first lease tee, various methods can be adopted. For example, the first lease fee re-determination unit 121 re-predicts a predictive value at the expiration of the scheduled lease term of the drive battery 710 based on the degradation state of the drive battery 710 to redetermine, as the first lease fee of the drive battery 710, a value obtained by multiplying, by a predetermined lease fee rate, a predicted decrease value as a result of subtracting the predictive value from the current value of the drive battery 710.

Further, as the method used by the first lease lee re-determination unit 121 to re-predict the predictive, value at the expiration of the scheduled lease term, various methods can be adopted. For example, the first lease fee re-determination unit 121 refers to the application DB 155 to estimate a reuse application after the expiration of the scheduled lease term based on the degradation state of the drive battery 710 during the first lease, estimates the amount of profit obtained by reusing the drive battery 710 in the reuse application by a predetermined algorithm, and re-predicts a value obtained by multiplying the amount of profit by a predetermined expected value as the predictive value at the expiration of the scheduled lease term of the drive battery 710.

On the other hand, when the cause of the abnormal degradation state does not occur as the result of the fact that the user of the drive battery 710 used the drive battery 710 in the way different from the planned usage information (FIG. 5/S280: No), the exchange recommendation unit 131 generates information to recommend the battery exchange (FIG. 5/S310), and transmits the information to the vehicle dealer management unit 50, for example.

The lease system of the present embodiment repeatedly executes the series of processes, for example, until the expiration time of the scheduled lease term comes (FIG. 4A/S400: Yes).

Note that, for example, the degradation cause estimation unit 129 gives a point to a planned usage content by a predetermined algorithm, gives a point to the usage history information of the drive battery 710 in a similar manner, compares both, and determines whether or not the difference therebetween is a predetermined level or more, to determine whether or not the cause of the abnormal degradation state occurs as a result of the fact that the user of the drive battery 710 used the drive battery 710 in a way different from the planned usage information.

### <Processes for Redetermining/Settling up First Lease Fee>

Processes for redetermining and settling, up the first lease fee upon returning will be described.

The first lease fee re-determination unit 121 redetermines the first lease fee based on the estimated degradation state and the degradation state of the returned battery.

As the method used by the first lease fee re-determination unit 121 to redetermine the first lease fee, various methods can be adopted. For example, the first lease fee re-determination unit 121 refers to the application DB 155 to recognize a reuse application of the drive battery 710 based on the degradation state of the returned drive battery 710, predicts the amount of profit obtained by leasing, the returned drive battery 710 in the reuse application, and redetermines, as the first lease fee of the drive battery 710, the amount of money obtained by subtracting the predictive value from the value before the first lease of the drive battery 710.

Then, the lease fee re-determination unit 121 compares the total amount received as the total amount of first lease fee paid during he first lease term with the total billing amount as the total amount of redetermined first lease, fee, charges the user for the difference when the total billing amount is larger than the total amount received or settles the first lease tee by returning the difference to the user Mien the total billing amount is smaller than the total amount received.

As described above, according to the present invention, there can be provided the battery lease system capable of rationalizing the burden of the user when using the battery and encouraging the purchase of an electric vehicle or the like effectively.

While the embodiment of the present invention has been described above, the present invention is not limited to this embodiment. Various changes can be made without departing from the scope of the present invention.

For example, the reuse application determination unit 123 may also be configured to determine a reuse application of the drive battery 710 based on the degradation state and degradation trend of the returned drive battery 710, or the second lease fee determination unit 125 may be configured to determine the second lease fee based on the reuse application and degradation trend of the drive battery 710.

In this case, as the methods used by the reuse application determination unit 123 and the second lease fee determination unit 125 to determine the reuse application and the second lease fee, respectively, various known methods may be used.

Alternatively, for example, the configuration may be such that the battery information acquisition unit 117 acquires battery information of the drive battery 710 during the first lease regularly or irregularly while the first lease is in progress, the degradation state determination unit 119 determines the degradation state of the drive battery 710 daring the first lease based on the battery information, and the output control unit of the lease management device 30 outputs, to the lease management device, information indicative of the degradation state of the drive battery 710 during the first lease based on the degradation state of the drive battery 710.

Alternatively, for example, some of the components or the processes may be omitted in a range that does not impart the effects of the system. Further, some or all of the components included in the server 10 in the above may be included, for example, in the lease management device 30 or the vehicle dealer management unit 50, or some or all of the components included in the lease management device 30 or the vehicle dealer management unit 50 may he included in the server 10.

Further, in the above, the embodiment of the lease system, for example, for the drive battery 710 of an electric vehicle or a hybrid vehicle (or for a reuse battery that was the drive battery 710 of the electric vehicle or the hybrid vehicle) is described, but the present invention is not limited thereto.

In other words, for example, a device with the battery installed therein is not limited to the electric vehicle or the hybrid vehicle, and the device may also be any other moving body, such as an electric bike or that for slow mobility (an electric wheelchair or that for a person with walking disability), or a battery storage system (a so-called ESS) for home or business.

In this case, for example, a management device of a handling company for the electric bike, the slow mobility, or the storage battery system is provided instead of the vehicle dealer management unit 50. Further, in this case, the planned usage information includes, for example, planned driving time during the lease, planned operating hours, the device type, and the like. Especially, in the case of the storage battery system, the size of house or office, the family structure, the number of employees, and the like are included in the planned usage information.

Further, it is assumed that the battery on lease is installed in a battery-replicable electric vehicle or a storage battery system. Therefore, the present invention can also be applied to a system to determine a lease fee of a battery according to the remaining capacity of the battery leased last time when the battery is leased to a user in a mechanism called a battery station for lending replaceable batteries to users.

### DESCRIPTION OF REFERENCE NUMERALS

0 . . . server, 30 . . . lease management device, 70 . . . vehicle, 111 . . . input reception unit, 113 . . . degradation estimation unit, 115 . . . first lease fee determination unit, 117 . . . battery information acquisition unit, 119 . . . degradation state determination unit, 121 . . . first lease fee re-determination unit, 123 . . . reuse application determination unit, 125 . . . second lease fee determination unit, 127 . . . usage history acquisition unit, 129 . . . degradation cause estimation unit, 131 . . . exchange recommendation unit, 133 . . . degradation trend acquisition unit, 150 . . . server storage unit, 710 . . . drive battery, 730 . . . usage history recording unit.

1. A battery lease system comprising:
an input reception unit;
a degradation estimation unit;
a first lease fee determination unit;
a storage unit;
a battery information acquisition unit;
a degradation state determination unit;
a lease fee re-determination unit
a usage history recording unit; a usage history acquisition unit; and
a degradation cause estimation unit,
wherein:
the input reception unit accepts input of estimation basic information including a scheduled lease term of a battery as a lease target and required to estimate a degradation state of the battery at the expiration of the scheduled lease term, and planned usage information composed of information indicative of planned discharge amount during the scheduled lease term of the lease target,
the degradation estimation unit estimates an estimated degradation state of the battery at the expiration of the scheduled lease term based on the estimation basic information,
the lease fee determination unit determines a lease fee of the battery based on the estimated degradation state,
the input reception unit input of information indicating that the lease of the battery is started and stores the input information in the storage unit, and stores, in the storage unit, the estimated degradation state and the planned usage information,
the usage history recording unit records usage history information of the battery during the lease while the lease of the battery is in progress,
the usage history acquisition unit acquires the usage history information recorded by the usage history recording unit,
the battery information acquisition unit acquires battery information required to determine a degradation state of the battery during the lease,
the degradation state determination unit determines the degradation state of the battery during the lease based on the battery information,
the degradation cause estimation unit determines whether or not the degradation state of the battery determined by the degradation state determination unit is abnormal compared with the estimated degradation state, and in a case of determining that the degradation state is abnormal, the degradation cause estimation unit estimates a cause of the abnormal degradation state based on the planned usage information and the usage history information, and
in a case where the cause estimated by the degradation cause estimation unit occurs as a result of a user of the battery using the battery in a way different from the planned usage information, the lease fee re-determination unit redetermines the lease fee based on the usage history information and the degradation state of the battery determined by the degradation state determination unit.

2-10. (canceled)

11. The battery lease system according to claim 1, further comprising:
an exchange recommendation unit which generates information to recommend the battery exchange in a case where the cause estimated by the degradation cause estimation unit does not occur as the result of the user of the battery using the battery in the way different from the planned usage information.

12. A battery lease system comprising:
an input reception unit;
a degradation estimation unit;
a lease fee determination unit; a storage unit;
a battery information acquisition unit;
a degradation state determination unit;
a reuse application determination unit; a usage history recording unit;
a usage history acquisition unit; and a degradation trend acquisition unit,
wherein:
the input reception unit accepts input of estimation basic information including a scheduled lease term of a battery as a lease target and required to estimate a degradation state of the battery at an expiration of the scheduled lease term,
the degradation estimation unit estimates an estimated degradation state of the battery at the expiration of the scheduled lease term based on the estimation basic information,
the lease fee determination unit determines a lease fee of the battery based on the estimated degradation state,
the input reception unit accepts input of information indicating that the lease of
the battery is started and stores the input information in the storage unit,
the usage history recording unit records usage history information of the battery during the lease while the lease of the battery is in progress,
the battery information acquisition unit acquires battery information required to determine a degradation state of the battery returned after the expiration of the lease of the battery,
the degradation state determination unit determines the degradation state of the returned battery based on the battery information,
the usage history acquisition unit acquires the usage history information of the battery returned after the expiration of the lease of the battery,
the degradation trend acquisition unit acquires a degradation trend of the battery based on the usage history information, and
the reuse application determination unit determines a reuse application as a next application of the battery based on the degradation state of the returned battery, and the lease fee determination unit determines a lease fee for a lease in the reuse application of the battery based on the reuse application of the battery and the degradation trend, or
the reuse application determination unit determines the reuse application of the battery based on the degradation state of the returned battery and the degradation trend, and the lease fee determination unit determines the lease fee in the reuse application of the battery based on the reuse application.

13. The battery lease system according to claim 12, wherein:
the degradation trend acquisition unit has a degradation trend determination model with the usage history information of the battery as input and the degradation trend of the battery as output,
the degradation trend acquisition unit learns, as training data, the usage history information of the battery and the degradation state of the battery after being used as indicated by the usage history information, and updates the degradation trend determination model regularly or irregularly, and
the degradation trend acquisition unit acquires the degradation trend of the battery using the usage history information and the degradation trend determination model.
